(19) United States
(12) Patent Application Publication
(10) Pub. No.: US 2025/0259130 A1
(43) Pub. Date: Aug. 14, 2025

(54) AI-ENABLED AUTOMATED PERFORMANCE MONITORING METHOD AND SYSTEM

(71) Applicant: JUGL, Frisco, TX (US)

(72) Inventors: Arun Prasad Jaganathan, Prosper, TX (US); Arun Kumar Ponnusamy, Frisco, TX (US)

(21) Appl. No.: 18/439,758

(22) Filed: Feb. 12, 2024

(51) Int. Cl. G06Q 10/0639

(52) U.S. Cl. CPC G06Q 10/06398

(57) ABSTRACT

The present invention discloses an AI-enabled automated performance monitoring method and system for efficiently monitoring and evaluating the performance of one or more users in various tasks. The method involves receiving user feedback, processing it with an AI module to extract validation points, validating these points against internal and external databases, and generating refined feedback. The system comprises a user interface, internal and external databases, an AI module, and a second internal database for continuous improvement.

### FIELD OF INVENTION

This invention relates generally to performance monitoring systems, and more specifically, to an AI-enabled automated method and system for monitoring the performance of one or more users across various tasks.

### BACKGROUND OF THE INVENTION

In the modern business landscape, monitoring and optimizing employee performance is of paramount importance to achieve organizational goals and maintain competitiveness. Conventional methods of performance appraisal often suffer from subjectivity, inconsistency, and infrequency. Such methods are designed to monitor performance of employees based on the data available within the company's internal database only and fails to include external factors. These limitations can result in inadequate feedback, demotivated employees, and suboptimal performance.

Furthermore, traditional methods often involve manual evaluations, which are time-consuming and may lack consistency. The need for an automated system that utilizes advanced AI technologies to monitor and provide feedback on user performance is evident.

The conventional performance monitoring systems and methods are designed for monitoring the performance of desk job employees and fail to efficiently monitor the performance of field job employees.

Existing performance evaluation systems typically rely on annual or periodic reviews conducted by supervisors, which can be time-consuming and biased. Moreover, they may not always be based on objective data, leading to inaccurate assessments. As a result, there is a need for a system and method that offer a more accurate, efficient, and data-driven approach to monitoring employee performance.

### SUMMARY OF THE INVENTION

In view of the foregoing disadvantages inherent in the prior art, the general purpose of the present disclosure is to provide a method and a system for monitoring employee performance, to include all advantages of the prior art, and to overcome the drawbacks inherent in the prior art.

Some of the objects of the present disclosure, which at least one embodiment herein satisfies, are as follows:

An object of the present disclosure is to ameliorate one or more problems of the prior art or to at least provide a useful alternative. An object of the present disclosure is to provide an AI-enabled automated performance monitoring method for monitoring performance of a user.

Another object of the present disclosure is to provide AI-enabled automated performance monitoring system for monitoring performance of a user.

Other objects and advantages of the present disclosure will be more apparent from the following description, which is not intended to limit the scope of the present disclosure.

In view of the above objects, in one aspect, the current disclosure provides a method and a system for monitoring, evaluating, and improving employee performance and the company's efficiency.

In an aspect, the present disclosure provides an AI-enabled automated performance monitoring method (hereinafter referred to as “the method”) for monitoring the performance of one or more user in a company. The method begins with the step of receiving, via a user interface, a first set of feedbacks related to a task from one or more user. The user interface is accessible through a web application or a mobile application. Then followed by a step of processing the first set of feedbacks to extract one or more validation points, via the AI module. Then followed by a step of validating the validation points with data available in a first internal database and an external database, via the AI module. Then followed by a step of generating a second set of feedbacks based on the validation for the user, via the AI module.

In an embodiment, the method further comprises step of updating a second internal database with the second set of feedbacks to fine-tune a performance monitoring module to evaluate the user's performance.

The performance parameters include productivity metrics, quality metrics, and time-based metrics related to the tasks performed by the user. The performance parameters are collected in real-time or periodically during the task and at the completion of the task.

Further, to validate the answer given by the user, the AI module runs a step segregating the validation points into one or more internal validation points and one or more external validation points. Then followed by a step of generating a first query based on the internal validation point and a second query based on the external validation point, via the AI module. Then the AI module runs the first query, on the first internal database to gather one more first data to validate the first set of feedbacks. The AI module runs the second query, on the external database to gather one or more second data to validate the first set of feedbacks. Then the AI module checks the authenticity of the first set of feedbacks based on the first data and the second data.

In an embodiment, while receiving the first set of feedbacks, the AI module is also configured to ask one or more questions to the user required to identify the validation points of the first set of feedbacks.

The first database has performance parameters of one or more tasks and one or more historical data related to one or more users of the company, productivity metrics, quality metrics, and time-based metrics related to the users and the tasks performed by the users. The first internal database and the second internal database are parts of a relational database system. The external database includes one or more internet sites or a third-party database having industry benchmarks and performance parameters data from other companies. The AI module continuously adapts its validation process based on the data stored in the first internal database.

In an embodiment, the AI module uses one or more artificial neural network machine learning algorithms to predict the validation points and the second set of feedbacks. Further, the AI module employs one or more natural language processing techniques to identify sentiments of the first set of feedbacks.

In another embodiment, the method further comprises notifying one or more supervisors or managers about the second set of feedbacks.

In another aspect, the present invention provides an AI-enabled automated performance monitoring system for monitoring performance of one or more user in one or more task (hereinafter referred as “system”). The system comprises a user interface, a first internal database, a second internal database, an external database, and an AI module. The user interface is configured to take a first set of feedback related to a task from one or more user and optionally ask one or more questions related to the task to the user. The user interface is accessible through a web application or a mobile application.

The first internal database is configured to store one or more performance parameters related to a task and one or more historical data related to one or more users of the company. The external database has real-time data of one or more events associated with the task or the users. The AI module is communicably coupled to the user interface, the first database and the external database, wherein the AI module is configured to extract one or more validation points from the first set feedbacks, ask one or more questions to the user required to identify the validation points of the first set of feedbacks, validate the validation point with data available in the first internal database and the external database, and generate a second set of feedbacks based on the validation of the validation points. The second internal database communicably coupled with the AI module, wherein the second internal database is configured to store the second set feedbacks to fine-tune the AI module.

In an embodiment, the system further comprises a performance monitoring module communicably coupled with the second internal data base, wherein the second set of feedbacks is used to evaluate the user's performance.

One of the key features of the invention is the AI module, which uses advanced one or more artificial neural network machine learning algorithms to predict the validation points and the second set of feedbacks. Furthermore, the AI module employs one or more natural language processing techniques to identify sentiments of the first set of feedbacks. The AI module is designed to adapt and improve its validation process continuously, ensuring accurate and up-to-date assessments.

### BRIEF DESCRIPTION OF DRAWING

The foregoing summary, as well as the following detailed description of various embodiments, is better understood when read in conjunction with the drawings provided herein. For the purposes of illustration, there are shown in the drawing exemplary embodiments; however, the presently disclosed subject matter is not limited to the specific methods and instrumentalities disclosed.

FIG. 1 illustrates a flowchart illustrating an AI-enabled automated performance monitoring method for monitoring performance of a user, according to an aspect of the present disclosure;

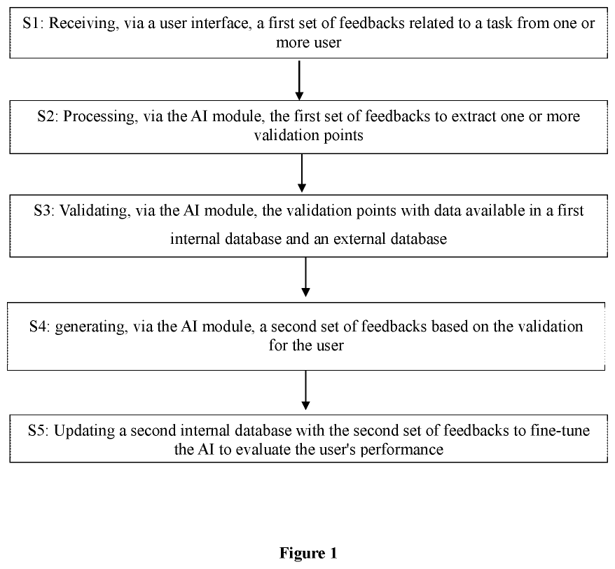

FIG. 2 illustrates a flowchart illustrating the process steps for validation of the validation point in the method, according to an embodiment of the present disclosure;

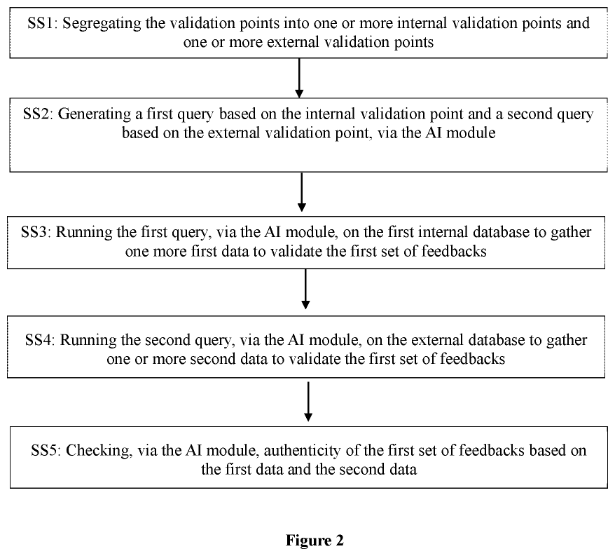

FIG. 3 illustrates a schematic view of an AI-enabled automated performance monitoring system for monitoring performance of a user, according to another aspect of the present disclosure disclosed herein;

FIG. 4 illustrates a block diagram of the AI module, according to an embodiment of the present invention;

FIG. 5 illustrate a first layout of a user interface, according to an embodiment of the present invention;

FIG. 6 illustrate a second layout of the user interface, according to an embodiment of the present invention; and

FIG. 7 illustrate a third layout of a user interface, according to an embodiment of the present invention.

Like reference numerals refer to like parts throughout the description of several views of the drawing.

### DETAILED DESCRIPTION

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open-ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The following detailed description should be read with reference to the drawings, in which similar elements in different drawings are identified with the same reference numbers. The drawings, which are not necessarily to scale, depict illustrative embodiments and are not intended to limit the scope of the disclosure.

It is to be understood that both the foregoing general description and the following detailed description are exemplary and explanatory only and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

Furthermore, the term “module”, as used herein, refers to logic embodied in hardware or firmware, or to a collection of software instructions, written in a programming language, such as, Java, C, C++, python, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “user”, as used herein, refers to client, or employer, or task creator, or employee.

The present disclosure is directed toward a method and system with a comprehensive approach to performance monitoring in a company. It leverages a unique set of steps to create an integrated and automated system that continuously assesses employee performance, facilitates self-improvement, and provides actionable feedback.

In an aspect, the present disclosure provides an AI-enabled automated performance monitoring method (hereinafter referred to as “the method”) for monitoring the performance of one or more user in a company. The method begins with the step of receiving, via a user interface, a first set of feedbacks related to a task from one or more user. The user interface is accessible through a web application or a mobile application. Then followed by a step of processing the first set of feedbacks to extract one or more validation points, via the AI module. Then followed by a step of validating the validation points with data available in a first internal database and an external database, via the AI module. Then followed by a step of generating a second set of feedbacks based on the validation for the user, via the AI module.

In an embodiment, the method further comprises step of updating a second internal database with the second set of feedbacks to fine-tune a performance monitoring module to evaluate the user's performance.

The performance parameters include productivity metrics, quality metrics, and time-based metrics related to the tasks performed by the user. The performance parameters are collected in real-time or periodically during the task and at the completion of the task.

Further, to validate the answer given by the user, the AI module runs a step segregating the validation points into one or more internal validation points and one or more external validation points. Then followed by a step of generating a first query based on the internal validation point and a second query based on the external validation point, via the AI module. Then the AI module runs the first query, on the second internal database to gather one more first data to validate the first set of feedbacks. The AI module runs the second query, on the external database to gather one or more second data to validate the first set of feedbacks. Then the AI module checks the authenticity of the first set of feedbacks based on the first data and the second data.

In an embodiment, while receiving the first set of feedbacks, the AI module is also configured to ask one or more questions to the user required to identify the validation points of the first set of feedbacks.

The first database has performance parameters of one or more tasks and one or more historical data related to one or more users of the company, productivity metrics, quality metrics, and time-based metrics related to the users and the tasks performed by the users. The first internal database and the second internal database are parts of a relational database system. The external database includes one or more internet sites or a third-party database having industry benchmarks and performance parameters data from other companies. The AI module continuously adapts its validation process based on the data stored in the first internal database.

In an embodiment, the AI module uses one or more artificial neural network machine learning algorithms to predict the validation points and the second set of feedbacks. Further, the AI module employs one or more natural language processing techniques to identify sentiments of the first set of feedbacks.

In another embodiment, the method further comprises notifying one or more supervisors or managers about the second set of feedbacks.

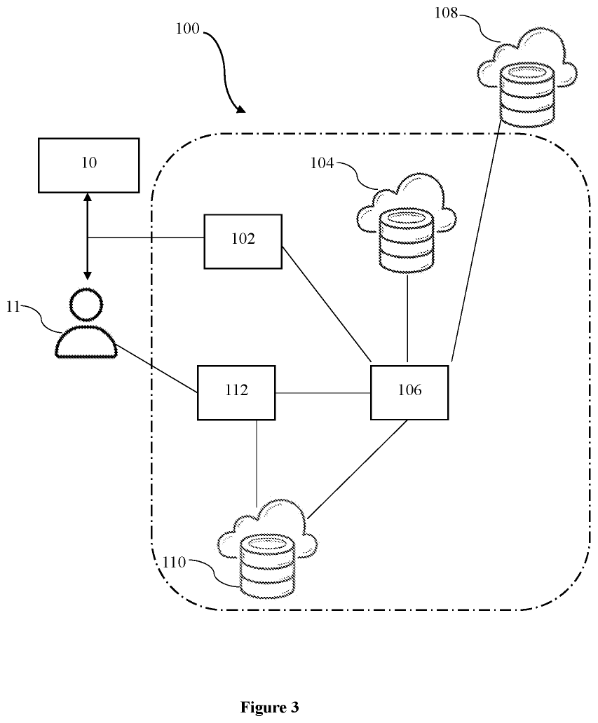

In another aspect, as illustrated in FIG. 3, the present invention provides an AI-enabled automated performance monitoring system (100) (hereinafter referred as “system”) for monitoring performance of one or more user (11) in one or more task (10). The system (100) comprises a user interface (102), a first internal database (104), an AI module (106), a second internal database (110), and an external database (108). The user interface (102) is configured to take a first set of feedback related to a task (10) from one or more user (11) and optionally ask one or more questions related to the task (10) to the user (11). The user interface (102) is accessible through a web application or a mobile application.

The first internal database (104) is configured to store one or more performance parameters related to a task and one or more historical data related to one or more users (11) of the company. The external database (108) has real-time data of one or more events associated with the task or the users. The first internal database (104) may include one or more non-transitory memory devices, including volatile and non-volatile memory devices. The first internal database (104) is depicting a system memory or a computer-readable storage media. The first internal database (104) may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within a computer system, such as during start-up, may typically be stored in the ROM. The RAM typically contains data and/or program modules that are presently being operated and executed by processing subsystem. In some implementations, the first internal database (104) may include multiple different types of memory, such as static random-access memory (SRAM), dynamic random-access memory (DRAM), and the like.

The AI module (106) is communicably coupled to the user interface (102), the first internal database (104), the external database (108) and the second internal database (110), wherein the AI module (106) is configured to extract one or more validation points from the first set feedbacks, ask one or more questions to the user required to identify the validation points of the first set of feedbacks, validate the validation point with data available in the first internal database (104) and the external database (108), and generate a second set of feedbacks based on the validation of the validation points. The second internal database (110) communicably coupled with the AI module (106), wherein the second internal database is configured to store the second set feedbacks to fine-tune the AI module (106).

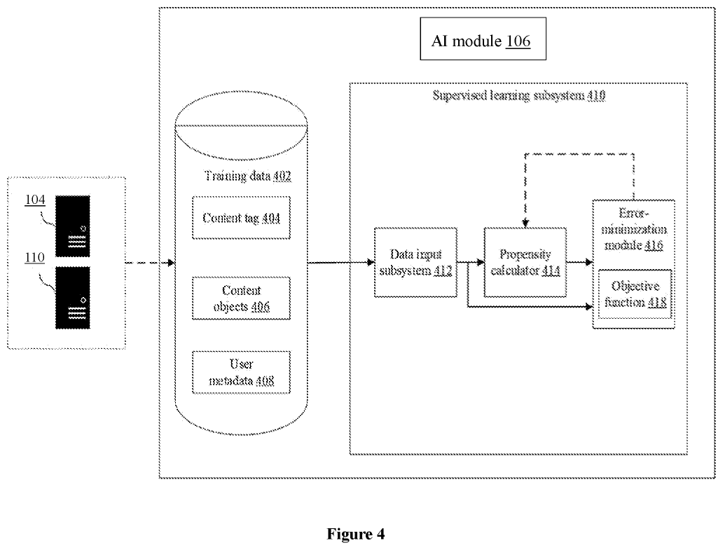

FIG. 4 illustrates a block diagram of the AI module 106, according to an embodiment of the present invention. More specifically, in some embodiments, The AI module 106 may be trained using training data 402. The training data 402 may be populated by data received from the multiple media sources, such as an external database 110 and a first internal database 104. The AI module 106 may be or include a non-binary classifier, such as a multinomial logistic regression model implemented in a neural network, trained to predict a probability that an input can be mapped to one or more classes of a set of classes, corresponding to content tags 404 or user characteristics from user metadata 408. As such, training the AI module 106 may include applying a supervised learning technique using one or more labelled sets of training data 402, which may include content tags 404, content objects 406, and user metadata 408. The user metadata 408 may include data related to the user. The content objects 406 may comprise data related to all the tasks accomplished by the user. The content tags 404 may be drawn from a database of features that the feature prediction models are trained to identify. As such, the content tags 404 may correspond to the features that may characterize content objects processed by the AI module 106.

The training data may be provided to a supervised learning subsystem 410. For example, the supervised learning subsystem 410 may comprise a data input subsystem 412 to receive the training data 402. As part of supervised training, the supervised learning subsystem 410 may use the training data 402 to define a ground truth, such that elements defining a mapping of the content tags 404 and user characteristics from the user metadata 408 are provided to a propensity calculator 414 and an error minimization module 416. The error minimization module 416 may, in turn, implement an objective function 418, which may be an error function, for example, defined as a distance between the model output and the ground truth. In this way, training may include adjusting one or more weights and/or coefficients of the propensity calculator 414 over multiple iterations until the value of the objective function converges to a global minimum.

In some embodiments, the input to the propensity calculator 414 includes the characteristics of a set of users, and the output includes a vector of probability values corresponding to predicted content features. In this way, the propensity calculator 414 may be trained to map the content tags 404 of the training data 402 to the user metadata 408 of the training data 402, and, once trained, the propensity calculator 414 may be used to generate the propensity score. As trained, the propensity calculator may be able to determine the propensity score indicative of the extent to which the user has propensity for releasing user's data to at least one digital platform.

In some embodiments, the supervised learning subsystem 410 may implement hyperparametric tuning, in addition to supervised learning, to optimize the AI module 106. For example, one or more terms of the objective function 418 and/or the AI module 106 may be fine-tuned by varying parameters that are not learned, such as scalar weighting factors

In an embodiment, the system further comprises a performance monitoring module (112) communicably coupled with the second internal data base (110), wherein the second set of feedbacks is used to evaluate the user's performance.

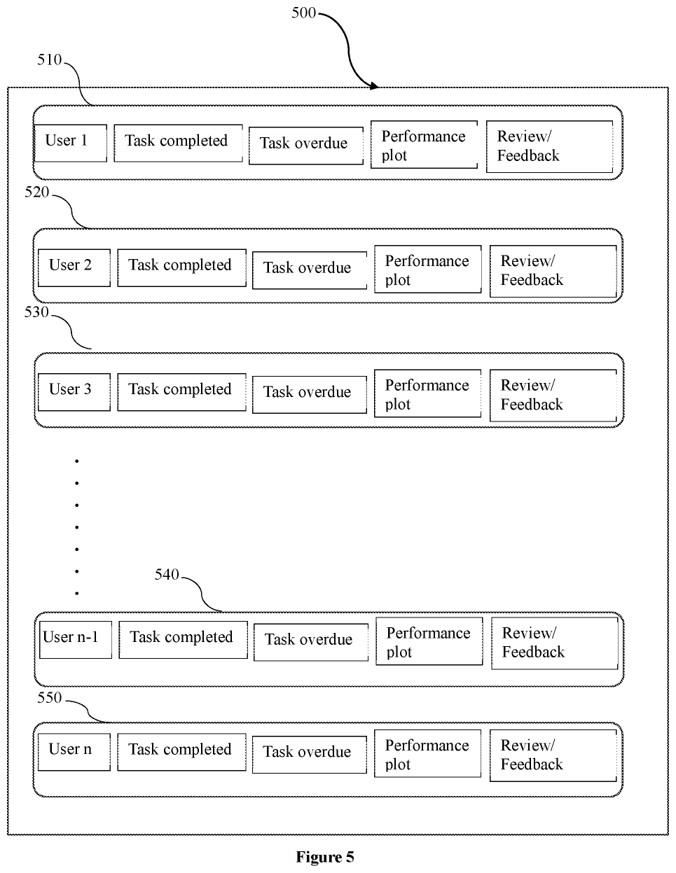

FIG. 5 illustrates a first layout 500 of a user interface 102, according to an embodiment of the present invention. The first layout 500 may be displayed on the user device associated with the user. The first layout 500 may include multiple elements indicating distinct items. For example, as illustrated in FIG. 5, the layout 500 includes an element, 510 for user 1, an element 520 for user 2, an element 530 for user 3, an element 540 for user n-1 and an element 550 for user n. Each element displays the performance column of a user, wherein the column may have sub-parts such as User id/name, task status, task overdue status, performance plot and review/feedback.

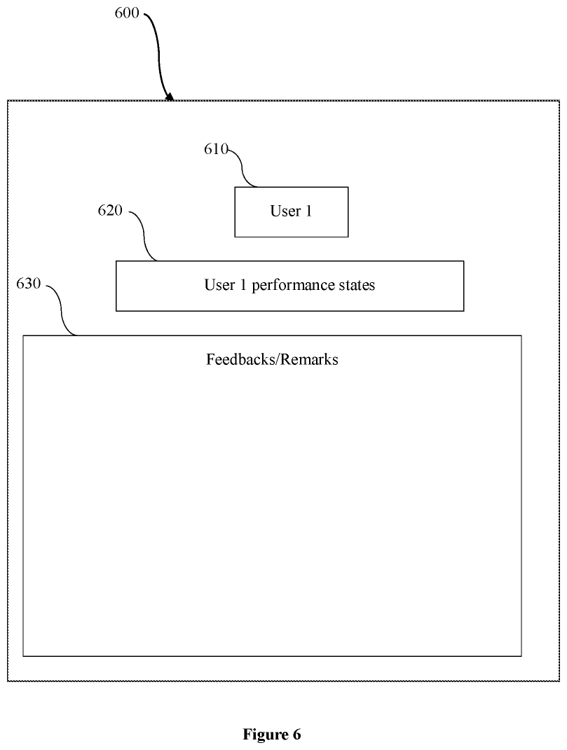

FIG. 6 illustrates a second layout 600 of the user interface 102, according to an embodiment of the present invention. Once the sub-part review/feedback is selected, a second layout 600 pops up over the first layout 500. The second layout includes element 610 to display user id, element 620 to display performance stats of the user, and element 630 may display a plurality of feedbacks/remarks provided by the AI module, supervisors and clients.

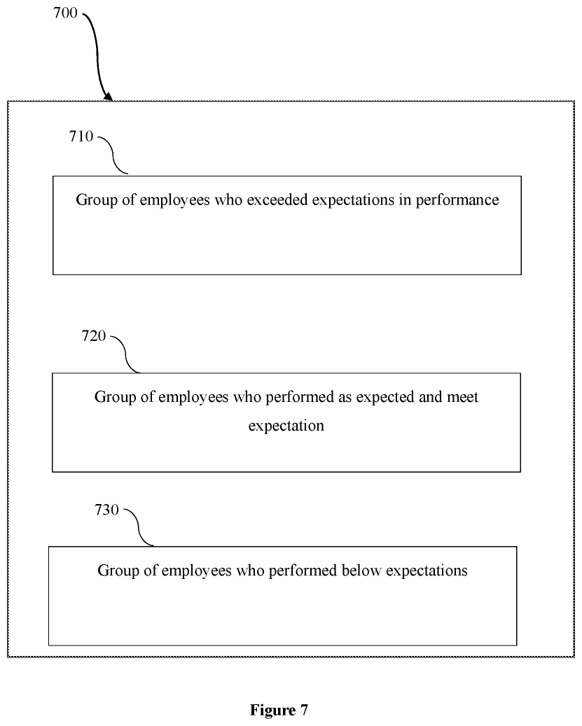

FIG. 7 illustrates a third layout 700 of the user interface 102, according to an embodiment of the present invention. In an embodiment, the user interface 102 has an option of the third layout. Once the third layout 700 option is selected in the user interface 102, a window pops up to display user ids of employees categorized in three categories depicted by elements 710, 720 and 730. The element 710 includes user ids of employees who exceeded expectations in performance. The element 720 includes user ids of employees who performed as expected and meet expectation. The element 730 includes user ids of employees who performed below expectations. The categorization of the employees is done by the AI module based on the second set of feedbacks.

One of the key features of the invention is the AI module, which uses advanced one or more artificial neural network machine learning algorithms to predict the validation points and the second set of feedbacks. Furthermore, the AI module employs one or more natural language processing techniques to identify sentiments of the first set of feedbacks. The AI module is designed to adapt and improve its validation process continuously, ensuring accurate and up-to-date assessments.

In an embodiment, these performance parameters are then compared to predetermined performance goals, which are tailored to the specific needs and objectives of the company. The comparison generates a predictive questioning process that asks employees questions related to their performance, aiming to pinpoint areas for improvement.

These questions are presented through a user interface, which is accessible via web applications or mobile applications, making it user-friendly and convenient for employees. The invention is flexible, allowing the questions to be uniquely tailored to each employee based on their performance parameters and the predetermined performance goals.

After employees provide answers to the predicted questions, the AI module validates these answers using data available in the internal database. In addition, the system is communicably coupled with an external database containing industry benchmarks and performance data from other companies to further validate and benchmark the answers.

The performance parameters are then revised based on the validation results, providing an accurate assessment of an employee's performance. The first internal database is updated with the revised performance parameters, questions, and answers, allowing the AI module to fine-tune its evaluation process continually.

The system also supports setting performance improvement goals for employees based on the revised performance parameters, enabling a structured approach to skill development and performance enhancement. The performance score is calculated based on a weighted combination of different performance parameters, ensuring that all aspects of an employee's work are considered.

Furthermore, the system includes mechanisms for notifying supervisors or managers of employee performance issues, and fostering real-time communication and intervention. A feedback loop is established to provide employees with guidance for self-improvement based on their performance data and feedback.

The first internal database and the second internal database is implemented as a relational database system, allowing efficient storage and retrieval of employee-related data. Storing the information in a structured database facilitates data analysis and historical tracking of employee performance.

The heart of the invention lies in the AI module, which is responsible for analysing the performance parameters. This module employs machine learning algorithms to evaluate the performance metrics, taking into account factors such as productivity, quality, and time-based metrics related to the tasks performed by employees. The AI module continuously adapts its evaluation process based on the collected data, ensuring that the performance assessment remains relevant and accurate.

The AI module compares the performance parameters calculated for each employee with a predetermined performance goal. This goal can be set based on various criteria, including company-specific performance metrics or historical performance data. The matching process determines whether an employee's performance meets or exceeds the set standards.

Once the matching process is complete, the system predicts questions that are tailored to each employee based on their unique performance parameters and the predetermined performance goal. These questions serve as a basis for assessing an employee's understanding of their role and tasks.

Employees are requested to provide answers to the predicted questions through the user interface. The user interface is accessed via a web application or a mobile application, providing a convenient and accessible platform for employees to respond to performance-related queries.

The answers provided by employees are subject to validation. This validation process is essential to ensure the accuracy and integrity of the performance evaluation. Validation is performed by using data available in the second internal database and by referencing an external database, which may contain industry benchmarks and performance data from other companies. The AI module employ natural language processing techniques to validate the answers, enhancing the accuracy of the validation process.

Based on the validation results, the performance parameters for each employee are revised. The revised performance parameters are a more accurate representation of an employee's performance, accounting for the validation of their responses to the questions. This revised score is then used for performance assessment and feedback.

In an embodiment, the second internal database is updated with the revised performance parameters, questions, and answers. This ongoing data collection and updating process contributes to the continuous improvement and fine-tuning of the AI module. The historical data stored in the internal database allows for trend analysis and the identification of areas where employees may require further support or improvement.

In yet another embodiment, the method further includes setting performance improvement goals for employees based on the revised performance parameters. This ensures that employees are provided with a clear path for enhancing their performance.

The performance score is calculated based on a weighted combination of different performance parameters. This allows for a more nuanced and comprehensive evaluation of an employee's performance.

The questions predicted by the system are tailored to each individual employee based on their unique performance history. This individualization ensures that the assessment remains relevant and specific to each employee's role and tasks.

In an embodiment, the system includes a feature for notifying supervisors or managers of employee performance issues based on the performance parameters. This facilitates timely intervention and support for employees who may be facing performance challenges.

To support employee development, the system can provide a feedback loop to employees based on their performance data and feedback. This encourages self-improvement and empowers employees to take ownership of their performance.

In addition to the method, the present invention also includes a computer program product comprising computer-readable instructions for executing the method described herein. This product allows for the implementation of the invention on various computing platforms and systems.

An information capturing module for receiving employee information and performance parameters. This module is responsible for collecting and inputting the necessary data into the performance monitoring system.

An internal database for storing the received information and performance parameters. This database serves as the central repository for all employee-related data.

An AI module for analysing performance parameters, predicting questions, validating answers with internal and external data, and revising performance parameters. The AI module is the core component of the system, responsible for the intelligent evaluation of employee performance.

A user interface that enables the system to request answers from employees. This interface can be accessed through web applications or mobile applications, making it convenient for employees to interact with the system.

A communication module is included to facilitate data exchange between the AI module and an external database. This external database may contain additional data sources and industry benchmarks for reference in the validation process.

The AI module can be hosted on a cloud-based platform or a local server, providing flexibility in terms of deployment options.

The present invention provides a comprehensive method and system for monitoring, evaluating, and improving employee performance in a company. By utilizing AI analysis and data validation techniques, the invention offers a data-driven, objective approach to performance assessment. This benefits both employees and employers by promoting a fair and accurate evaluation of performance and facilitating targeted performance improvement. The invention also includes a computer program product for easy implementation and a system for performance monitoring with various components to support the method's execution.

In an exemplary embodiment, a client gives feedback for a task performed by an employee of the company. The AI module runs a sentiment analysis on the feedback and asks questions to the client to get a first set of feedbacks regarding the performance of the employee while performing the task. In the first set of feedback the client provides inputs that the employee reached late to the client's location. The AI module then validates the first set of feedback with the first data available in the first internal database and second data available in the external database. The AI module checks the employee's reporting time history and identifies that the employee is always punctual tin the reporting time history. The AI module parallelly checks in the external database for the traffic and weather conditions during the time of task between the locations of client and employee. The AI module identifies that due to bad weather or traffic, the employee was not able to arrive on time. The AI module then generates a second set of feedback that the employee was late due to bad weather or traffic, and then communicates the second set of feedback to the client, employer, manager and task creator. The second set of feedback is stored in the second internal database to fine-tune the AI to evaluate the user's performance.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. An Artificial Intelligence (AI)-enabled automated performance monitoring method for monitoring performance of one or more users in one or more tasks, comprising steps of:
receiving, via a user interface, a first set of feedbacks related to the one or more tasks from the one or more users;
processing, via an Artificial Intelligence (AI) engine, the first set of feedbacks to extract one or more validation points;
validating, via the AI engine, the validation points with data stored available in an first internal memory device and an external memory device, wherein
the first internal memory device stores performance parameters of the one or more tasks and one or more historical data related to the one or more users of a company, productivity metrics, quality metrics, and time-based metrics related to the one or more users and the one or more tasks performed by the one or more users,
the validating of the validation points comprises:
segregating, via the AI engine, the validation points into one or more internal validation points and one or more external validation points;
generating, via the AI engine, a first query based on the one or more internal validation points and a second query based on the one or more external validation points;
running, via the AI engine, the first query on the first internal memory device to acquire one or more first data to validate the first set of feedbacks;
running, via the AI engine, the second query on the external memory device to acquire one or more second data to validate the first set of feedbacks; and
verifying, via the AI engine, authenticity of the first set of feedbacks based on the one or more first data and the one or more second data,
the AI engine is communicatively coupled to the user interface, the first internal memory device, a second internal memory device, and the external memory device,
the AI engine is trained for the validating of the validation points and performance evaluation of the one or more users, via a supervised learning process, based on training data, and
the supervised learning process comprises:
receiving, by the AI engine, the training data, for evaluation from at least one of the first internal memory device or the second internal memory device, wherein the training data comprises pre-identified data and unidentified data;
segregating, by the AI engine, the training data to at least one of content tags, content objects, and user metadata, wherein the content tags correspond to unidentified data of the training data, the content objects and the user metadata correspond to the pre-identified data of the training data, and the user metadata corresponds to metadata related to the one or more users;
evaluating, invariably, by a propensity calculator of the AI engine, the unidentified data for identifying the content tags, based on the pre-identified data;
executing, by an error-minimization module of the AI engine, an objective function to compute a degree of error in identifying the content tags, wherein the propensity calculator outputs data, the error-minimization module receives the output data from the propensity calculator and the training data for executing the objective function, and the error-minimization module outputs information related to the degree of error to the propensity calculator as feedback; and
changing, invariably, by the AI engine, at least a coefficient of the propensity calculator till the degree of error in identifying the content tags recede a value, wherein the changing of the at least the coefficient of the propensity calculator is based on the feedback from the error-minimization module, and the value is based on the changing of the at least the coefficient of the propensity calculator to minimize the degree of error;
optimizing, by the AI engine, the trained AI engine, in addition to the supervised learning process, by implementing a machine-readable set of instructions that corresponds to hyperparametric tuning; generating, via the trained AI engine, a second set of feedbacks for the one or more users, based on the validating of the validation points and the optimizing of the trained AI engine; and
updating, via the trained AI engine, the second internal memory device with the second set of feedbacks to fine-tune the performance evaluation of the one or more users, wherein the performance parameters of the one or more tasks is updated in the first internal memory device, based on the updating the second internal memory device with the second set of feedbacks.

2. (canceled)

3. (canceled)

4. The method as claimed in claim 1, wherein while receiving the first set of feedbacks, the AI engine is also configured to ask one or more questions to the one or more users required to identify the validation points of the first set of feedbacks.

5. (canceled)

6. The method as claimed in claim 1, wherein the AI engine uses one or more artificial neural network machine learning algorithms to predict the validation points and the second set of feedbacks.

7. The method as claimed in claim 1, wherein the AI engine employs one or more natural language processing techniques to identify sentiments of the first set of feedbacks.

8. The method as claimed in claim 1, wherein the user interface is accessible through a web application or a mobile application.

9. The method as claimed in claim 1, wherein the first internal memory device and the second internal memory device are parts of a relational database system.

10. The method as claimed in claim 1, wherein the external memory device includes real-time data, of one of one or more events associated with the one or more tasks or the one or more users, that is extracted from one of one or more internet sites or a third-party database that includes industry benchmarks and performance parameters data from other companies.

11. The method as claimed in claim 1, wherein the AI engine continuously adapts the validation process based on the data stored in the first internal memory device.

12. The method as claimed in claim 1, further comprises notifying one or more supervisors or managers, via the user interface, about the second set of feedbacks.

13. An Artificial Intelligence (AI)-enabled automated performance monitoring system for monitoring performance of one or more users in one or more tasks, the system comprises:
a user interface configured to take a first set of feedback related to the one or more tasks from the one or more users;
a first internal memory device configured to store one or more performance parameters related to the one or more tasks and one or more historical data related to the one or more users of the company;
an external memory device having real-time data of one or more events associated with the one or more tasks or the one or more users; and
an Artificial Intelligence (AI) engine communicably coupled to the user interface, the first internal memory device, a second internal memory device, and the external memory device, wherein the AI engine is configured to:
evaluate the first set of feedbacks and transmit query related to the one or more tasks to the one or more users for extracting one or more validation points from the first set feedbacks;
validate the validation points with data stored in the first internal memory device and the external memory device, wherein
the first internal memory device stores performance parameters of the one or more tasks and one or more historical data related to the one or more users of a company, productivity metrics, quality metrics, and time-based metrics related to the one or more users and the one or more tasks performed by the one or more users,
validation, via the AI engine, of the validation points comprises:
segregating the validation points into one or more internal validation points and one or more external validation points;
generating a first query based on the one or more internal validation points and a second query based on the one or more external validation points;
running the first query on the first internal memory device to acquire one or more first data to validate the first set of feedbacks;
running the second query on the external memory device to acquire one or more second data to validate the first set of feedbacks; and
verifying authenticity of the first set of feedbacks based on the one or more first data and the one or more second data,
the AI engine is trained for the validation of the validation points and performance evaluation of the one or more users, via a supervised learning process, based on training data, and
the supervised learning process comprises:
receiving, by the AI engine, the training data, for evaluation from at least one of the first internal memory device or the second internal memory device, wherein the training data comprises pre-identified data and unidentified data;
segregating, by the AI engine, the training data to at least one of content tags, content objects, and user metadata, wherein the content tags correspond to unidentified data of the training data, the content objects and the user metadata correspond to the pre-identified data of the training data, and the user metadata corresponds to metadata related to the one or more users;
evaluating, invariably, by a propensity calculator of the AI engine, the unidentified data for identifying the content tags, based on the pre-identified data;
executing, by an error-minimization module of the AI engine, an objective function to compute a degree of error in identifying the content tags, wherein the propensity calculator outputs data, the error-minimization module receives the output data from the propensity calculator and the training data for executing the objective function, and the error-minimization module outputs information related to the degree of error to the propensity calculator as feedback; and
changing, invariably, by the AI engine, at least a coefficient of the propensity calculator till the degree of error in identifying the content tags recede a value, wherein the changing of the at least the coefficient of the propensity calculator is based on the feedback from the error-minimization module, and the value is based on the changing of the at least the coefficient of the propensity calculator to minimize the degree of error;
optimize the trained AI engine, in addition to the supervised learning process, by implementing a machine-readable set of instructions that corresponds to hyperparametric tuning;
generate a second set of feedbacks for the one or more users, based on the validation of the validation points and optimization of the trained AI engine; and
a second internal memory device communicably coupled with the AI engine, wherein the second internal memory device is configured to store the second set feedbacks to fine-tune the AI engine and
update the second internal memory device with the second set of feedbacks to fine-tune the performance evaluation of the one or more users, wherein the performance parameters of the one or more tasks is updated in the first internal memory device, based on the update of the second internal memory device with the second set of feedbacks.

14. (canceled)

15. The system as claimed in claim 13, wherein the AI engine is hosted on a cloud-based platform or a local server.

16. The system as claimed in claim 13, wherein the AI engine uses one or more artificial neural network machine learning algorithms to predict the validation points and the second set of feedbacks.

17. The system as claimed in claim 13, wherein the AI engine employs one or more natural language processing techniques to identify sentiments of the first set of feedbacks.

18. The system as claimed in claim 13, wherein the user interface is accessible through a web application or a mobile application.

19. The system as claimed in claim 13, wherein the first internal memory device and the second internal memory device are parts of a relational database system.

20. The system as claimed in claim 13, wherein the AI engine continuously adapts the validation of the validation points, based on the data stored in the first internal memory device.
